(19) United States
(12) Patent Application Publication
(10) Pub. No.: US 2023/0256997 A1
(43) Pub. Date: Aug. 17, 2023

(54) INTELLIGENT BEAM PREDICTION METHOD

(71) Applicant: LG ELECTRONICS INC., Seoul (KR)

(72) Inventor: Kyungho LEE, Seoul (KR)

(73) Assignee: LG ELECTRONICS INC., Seoul (KR)

(21) Appl. No.: 18/008,046

(22) PCT Filed: Jun. 3, 2020
(86) PCT No.: PCT/KR2020/007195

§ 371 Date: Dec. 2, 2022

(51) Int. Cl. B60W 60/00; B60W 30/08; B60W 50/00; B60W 40/02; H04B 7/06

(52) U.S. Cl. CPC B60W 60/0015; B60W 30/08; B60W 50/00; B60W 40/02; H04B 7/06952; B60W 2554/80; B60W 2050/0062; B60W 2420/52

(57) ABSTRACT

Discussed is a method of predicting an intelligent beam of an autonomous vehicle in an autonomous driving system. The method can include obtaining sensing information for detecting one or more adjacent objects through at least one sensor of the autonomous vehicle, in response to an occurrence of a blockage event where a blocker detected on a line of sight (LOS) path between the autonomous vehicle and a target vehicle blocks the target vehicle, selecting some of a plurality of non-line of sight (NLOS) paths between the autonomous vehicle and the target vehicle to continue communication between the autonomous vehicle and the target vehicle, and selecting an optimal beam related to the target vehicle based on the selected one or more of the plurality of NLOS paths. The selecting of some of the plurality of NLOS paths can be performed based on a pre-trained machine learning network

### TECHNICAL FIELD

The present disclosure relates to a method of predicting an intelligent beam.

### BACKGROUND ART

Vehicles may be classified into an internal combustion engine vehicle, an external composition engine vehicle, a gas turbine vehicle, an electric vehicle, etc. based on types of motors used therefor.

An autonomous vehicle refers to a vehicle that can drive itself without an operation of a driver or a passenger. An autonomous driving system refers to a system that monitors and controls an autonomous vehicle so that the autonomous vehicle can drive itself.

The autonomous vehicle establishes a communication connection with a target vehicle, and discover an optimal beam for communication with the target vehicle through a beam tracking operation after the establishment. However, an optimal transmit (Tx) beam and/or receive (Rx) beam that has been determined once may vary as a relative position of each autonomous vehicle changes.

In a related art, a transmission autonomous vehicle periodically discovers an optimal Tx beam, and a reception autonomous vehicle periodically discovers an optimal Rx beam. In this instance, since all beam combinations are discovered whenever changes in the relative position of the target vehicle are detected, it takes a lot of time to discover the beam.

### DISCLOSURE

### Technical Problem

An object of the present disclosure is to address the above-described and other needs and/or problems.

Another object of the present disclosure is to implement a method of predicting an intelligent beam capable of reducing a beam discovery time using a neural network trained with information of an object directly related to a channel when tracking above 6 GHz (e.g., mmWave, THz, etc.) beam.

Another object of the present disclosure is to implement a method of predicting an intelligent beam capable of adjusting more accurately and quickly sizes of timing advance (TA) and/or Rx window even if there are many target vehicles or the target vehicles move quickly.

Another object of the present disclosure is to implement a method of predicting an intelligent beam capable of reducing the probability that communication links are broken by reducing a beam discovery time.

### Technical Solution

In one aspect of the present disclosure, there is provided a method of predicting an intelligent beam of an autonomous vehicle in an autonomous driving system, the method comprising obtaining sensing information for detecting one or more adjacent objects through at least one sensor; in response to an occurrence of an event where a blocker detected on a line of sight (LOS) path between the autonomous vehicle and a target vehicle blocks the target vehicle, selecting some of a plurality of NLOS paths to be formed between the autonomous vehicle and the target vehicle; and selecting an optimal beam related to the target vehicle based on the selected one or more NLOS paths.

The at least one sensor may include at least one of a lidar, a radar or a camera.

The sensing information may include an image including the target vehicle or the one or more objects.

one or more transmit (Tx) beam indexes may be predefined in the sensing information, and the one or more Tx beam indexes may correspond to one or more predefined beam directions.

The detecting may comprise detecting the one or more objects from the image based on a ray tracing technique or a convolutional neural network (CNN).

The NLOS path may be a reflected wave path or a refracted wave path formed by a reflector or a refractor.

Selecting some of the plurality of NLOS paths may be performed based on a pre-trained machine learning network. The machine learning network may be a sorter trained, as training data, on a dataset that sets an image including an object related to the NLOS path as an input and sets a success probability of a beam alignment as an output.

The autonomous vehicle and the target vehicle may perform above 6 GHz high frequency based communication.

The method may further comprise, when the event does not occur, not selecting some of the plurality of NLOS paths and selecting an optimal beam related to the target vehicle based on the LOS path.

The one or more objects may include at least a part of the blocker, the reflector, and the refractor.

When the event occurs by at least one of the one or more objects, the at least one object related to the occurrence of the event may be set as the blocker, and remaining one or more objects unrelated to the occurrence of the event may be set as a reflector or a refractor.

The method may further comprise, based on the sensing information or map information including the target vehicle, predicting a distance value of the NLOS path; and transmitting a beam at a power determined based on the distance value.

The method may further comprise, based on the sensing information or map information including the target vehicle, predicting a distance value of the NLOS path; and updating a TA value to a value determined based on the distance value.

The method may further comprise, based on the sensing information or map information including the target vehicle, predicting a distance value of the NLOS path; and updating a size of a receive (Rx) window to a value determined based on the distance value.

In another aspect of the present disclosure, there is provided an autonomous vehicle in a wireless communication system for autonomous driving, comprising one or more transceivers; one or more processors; and one or more memories connected to the one or more processors and configured to store instructions, wherein when the instructions are executed by the one or more processors, the instructions allow the one or more processors to support operations for predicting an intelligent beam, and wherein the operations comprise obtaining sensing information through at least one sensor; detecting one or more objects adjacent to the autonomous vehicle; in response to an occurrence of an event where a blocker detected on a line of sight (LOS) path between the autonomous vehicle and a target vehicle blocks the target vehicle, selecting some of a plurality of NLOS paths to be formed between the autonomous vehicle and the target vehicle; and selecting an optimal beam related to the target vehicle based on the selected one or more NLOS paths.

### Advantageous Effects

Effects of a method of predicting an intelligent beam according to an embodiment of the present disclosure are described as follows.

The present disclosure can reduce a beam discovery time using a neural network trained with information of an object directly related to a channel when tracking above 6 GHz (e.g., mmWave, THz, etc.) beam.

The present disclosure can adjust more accurately and quickly sizes of timing advance (TA) and/or Rx window even if there are many target vehicles or the target vehicles move quickly.

The present disclosure can reduce the probability that communication links are broken by reducing a beam discovery time.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### DESCRIPTION OF DRAWINGS

Accompanying drawings included as a part of the detailed description for helping understand the present disclosure provide embodiments of the present disclosure and are provided to describe technical features of the present disclosure with the detailed description.

FIG. 1 is a block diagram of a wireless communication system to which methods proposed in the disclosure are applicable.

FIG. 2 illustrates an example of a signal transmission/reception method in a wireless communication system.

FIG. 3 illustrates an example of basic operations of an autonomous vehicle and a 5G network in a 5G communication system.

FIG. 4 illustrates an example of a basic operation between vehicles using 5G communication.

FIG. 5 illustrates a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a diagram showing a signal flow in an autonomous vehicle according to an embodiment of the present disclosure.

FIG. 9 is a diagram referred to describe a usage scenario of a user according to an embodiment of the present disclosure.

FIG. 10 illustrates an example of V2X communication to which the present disclosure is applicable.

FIG. 11 illustrates a resource allocation method in a side-link where the V2X is used.

FIG. 12 illustrates an example diagram for explaining why a blockage by a blocker during above 6 GHz communication is a problem.

FIG. 13 is a flow chart illustrating a wireless communication method of a vehicle UE according to some embodiments of the present disclosure.

FIG. 14 is an example diagram for explaining a vision recognition process using a convolutional neural network applied to some embodiments of the present disclosure.

FIG. 15 is an example diagram for explaining a vision recognition process using a convolutional neural network applied to other some embodiments of the present disclosure.

FIG. 16 is an example diagram of a machine learning based beam tracking method applied to various embodiments of the present disclosure.

FIG. 17 is another example diagram of a machine learning based beam tracking method applied to various embodiments of the present disclosure.

FIG. 18 is a flow chart illustrating a method of adjusting a Tx beam intensity according to some embodiments of the present disclosure.

FIG. 19 illustrates an example of a method of adjusting a Tx beam intensity applied to some embodiments of the present disclosure.

FIG. 20 illustrates another example of a method of adjusting a Tx beam intensity applied to some embodiments of the present disclosure.

### MODE FOR INVENTION

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

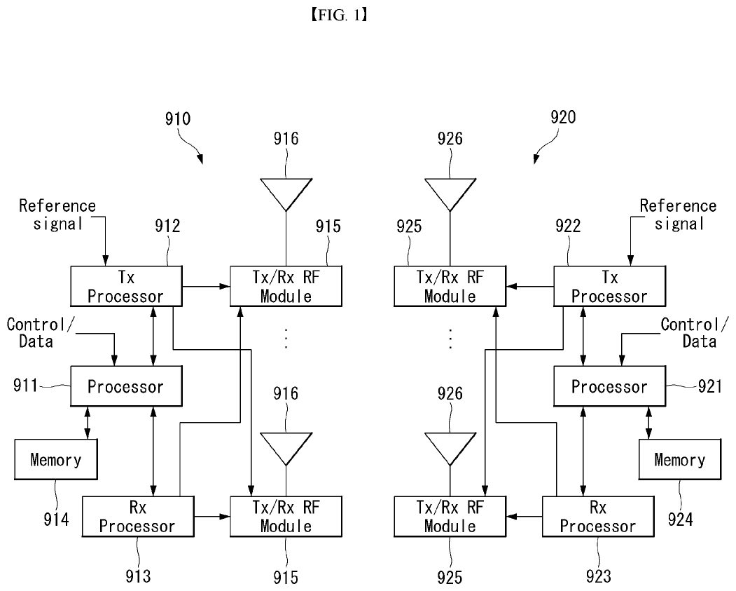

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

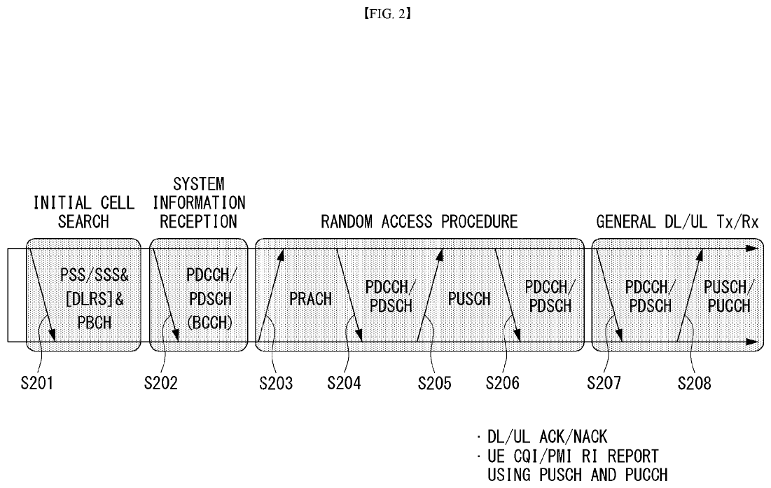

FIG. 2 illustrates physical channels and general signal transmission used in the 3GPP system.

In the wireless communication system, the UE receives information from the base station via downlink (DL) and transmits information to the base station via uplink (UL). The information that the base station and the UE transmit and receive includes data and various control information, and there are various physical channels according to a type/usage of the information that the base station and the UE transmit and receive.

When a UE is powered on or newly enters a cell, the UE performs an initial cell search operation such as synchronizing with a base station in S201. To this end, the UE may receive a primary synchronization signal (PSS) and a secondary synchronization signal (SSS) from the base station to synchronize with the base station and acquire information such as a cell ID. Thereafter, the UE may receive a physical broadcast channel (PBCH) from the base station and acquire in-cell broadcast information. The UE may receive a downlink reference signal (DL RS) in an initial cell search step to check a downlink channel state.

The UE that completes the initial cell search operation may receive a physical downlink control channel (PDCCH) and a physical downlink shared channel (PDSCH) according to information loaded on the PDCCH to acquire more specific system information, in S202.

If the UE first accesses the base station or there is no radio resource for signal transmission, the UE may perform a random access channel (RACH) procedure on the base station in S203 to S206. To this end, the UE may transmit a specific sequence to a preamble via a physical random access channel (PRACH) in S203 and S205, and receive a response message (random access response (RAR) message) to the preamble via the PDCCH and a corresponding PDSCH. In the case of a contention based RACH, a contention resolution procedure may be additionally performed in S206.

Next, the UE performing the above-described procedure may perform PDCCH/PDSCH reception (S207) and physical uplink shared channel (PUSCH)/physical uplink control channel (PUCCH) transmission (S208) as a general uplink/downlink signal transmission procedure. In particular, the UE may receive downlink control information (DCI) on the PDCCH. Here, the DCI may include control information such as resource allocation information for the UE, and different formats may be applied to the DCI according to the use purpose.

The control information that the UE transmits to the base station via the uplink or receives from the base station may include a downlink/uplink ACK/NACK signal, a channel quality indicator (CQI), a precoding matrix index (PMI), a rank indicator (RI), and the like. The UE may transmit the control information such as the CQI/PMI/RI, etc., on the PUSCH and/or PUCCH.

With reference to FIG. 2, an initial access (IA) procedure in a 5G communication system is additionally described.

The UE can perform cell search, system information acquisition, beam alignment for initial access, and DL measurement based on an SSB. The SSB is interchangeably used with a synchronization signal/physical broadcast channel (SS/PBCH) block.

The SSB includes a PSS, an SSS and a PBCH. The SSB consists of four consecutive OFDM symbols, and the PSS, the PBCH, the SSS/PBCH or the PBCH is transmitted per OFDM symbol. Each of the PSS and the SSS consists of one OFDM symbol and 127 subcarriers, and the PBCH consists of 3 OFDM symbols and 576 subcarriers.

The cell search refers to a process in which a UE acquires time/frequency synchronization of a cell and detects a cell identifier (ID) (e.g., physical layer cell ID (PCI)) of the cell. The PSS is used to detect a cell ID from a cell ID group, and the SSS is used to detect a cell ID group. The PBCH is used to detect an SSB (time) index and a half-frame.

There are 336 cell ID groups, and there are 3 cell IDs per cell ID group. A total of 1008 cell IDs are present. Information on a cell ID group to which a cell ID of a cell belongs is provided/acquired via an SSS of the cell, and information on the cell ID among 336 cell ID groups is provided/acquired via a PSS.

The SSB is periodically transmitted in accordance with SSB periodicity. A default SSB periodicity assumed by the UE during initial cell search is defined as 20 ms. After cell access, the SSB periodicity may be set to one of {5 ms, 10 ms, 20 ms, 40 ms, 80 ms, 160 ms} by a network (e.g., a BS).

Next, acquisition of system information (SI) is described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlockl) and is transmitted by a BS via a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

With reference to FIG. 2, a random access (RA) procedure in the 5G communication system is additionally described.

A random access procedure is used for various purposes. For example, the random access procedure can be used for network initial access, handover, and UE-triggered UL data transmission. The UE can acquire UL synchronization and UL transmission resources through the random access procedure. The random access procedure is classified into a contention-based random access procedure and a contention-free random access procedure. A detailed procedure for the contention-based random access procedure is as follows.

The UE can transmit a random access preamble via PRACH as Msg1 of a random access procedure in UL. Random access preamble sequences with two different lengths are supported. Long sequence length 839 is applied to subcarrier spacings of 1.25 kHz and 5 kHz, and short sequence length 139 is applied to subcarrier spacings of 15 kHz, 30 kHz, 60 kHz and 120 kHz.

When a BS receives the random access preamble from the UE, the BS sends a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, i.e., Msg1. Presence or absence of random access information with respect to Msg1 transmitted by the UE can be determined depending on presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission based on most recent path loss and a power ramping counter.

The UE can perform UL transmission as Msg3 of the random access procedure on a physical uplink shared channel based on the random access response information. The Msg3 may include an RRC connection request and a UE ID. The network may transmit Msg4 as a response to Msg3, and Msg4 can be handled as a contention resolution message on DL. The UE can enter an RRC connected state by receiving Msg4.

C. Beam Management (BM) Procedure of 5G-Communication System

ABM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequency Sect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

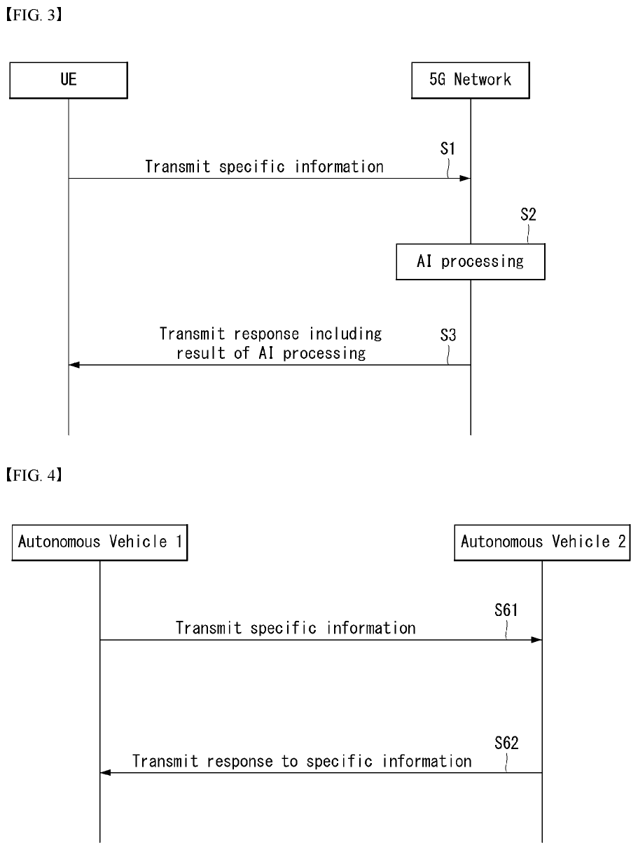

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PS SCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PS SCH.

The above-described 5G communication technology can be combined with methods proposed in the present disclosure which will be described later and applied or can complement the methods proposed in the present disclosure to make technical features of the methods concrete and clear.

DrivinG

(1) Exterior of Vehicle

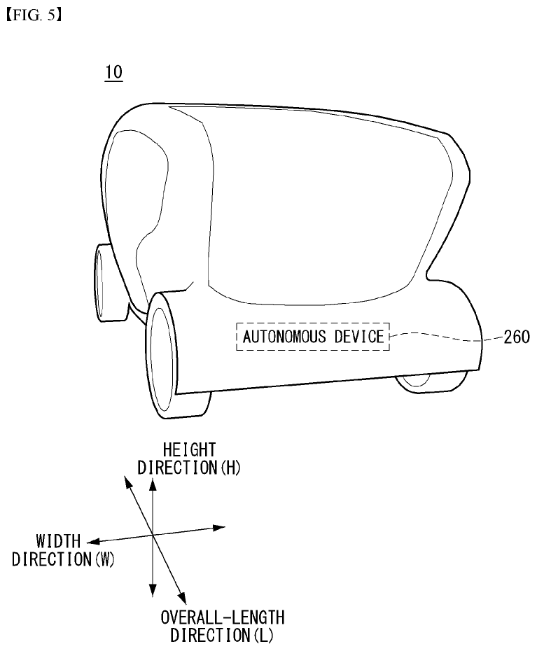

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

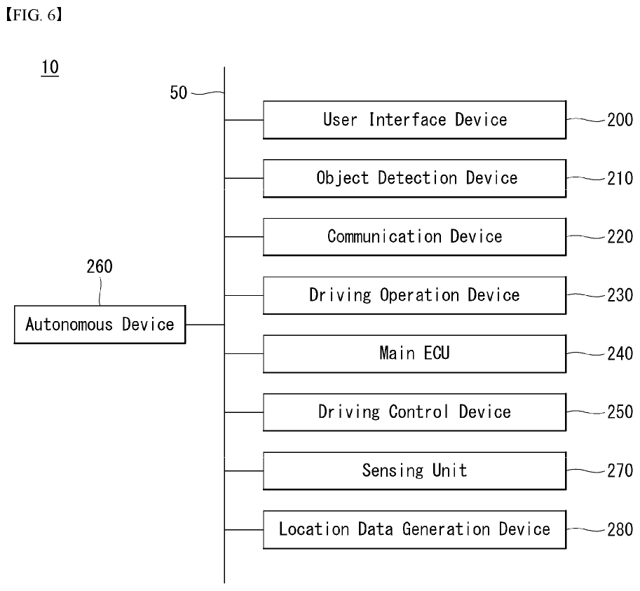

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

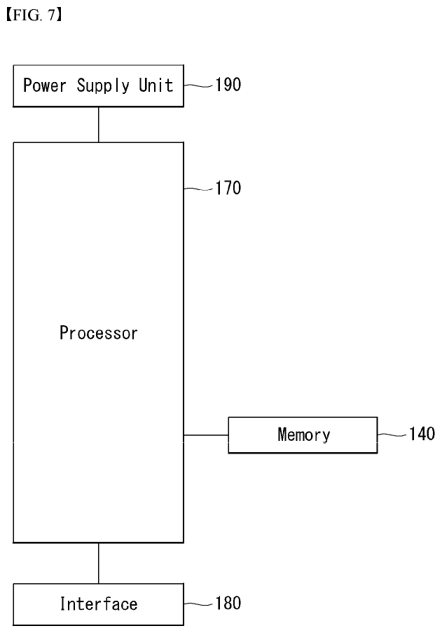

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

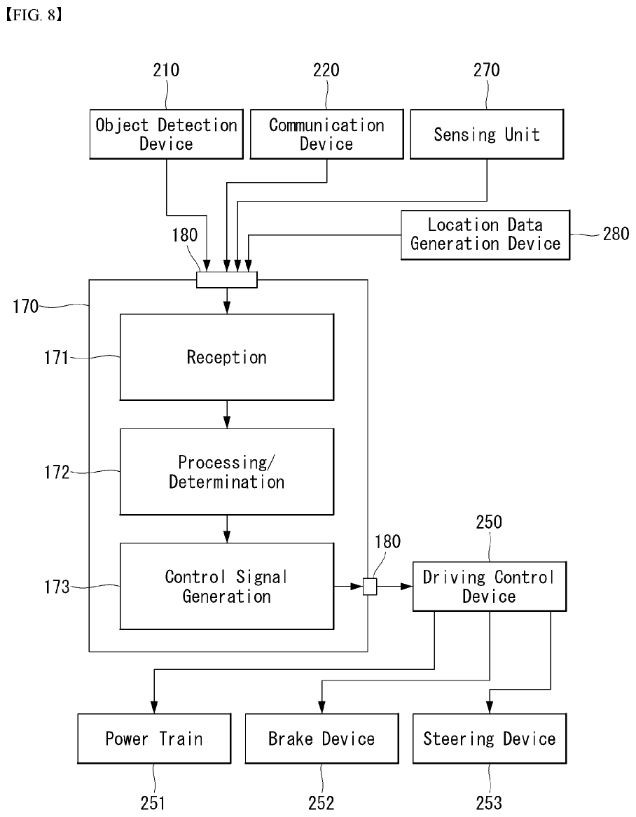

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Autonomous Vehicle Usage Scenario

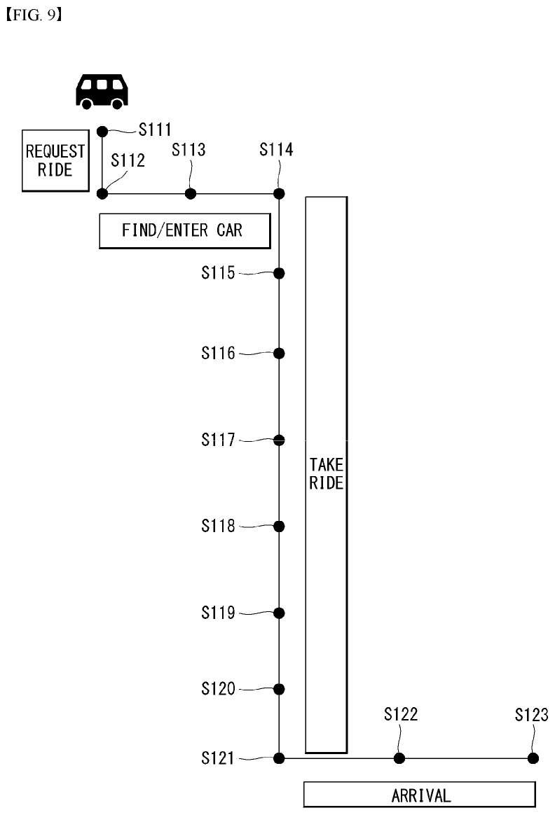

FIG. 9 is a diagram referred to describe a usage scenario of the user according to an embodiment of the present disclosure.

1) Destination Forecast Scenario

A first scenario S111 is a destination forecast scenario of the user. A user terminal may install an application that can be linked with a cabin system 300. The user terminal can forecast the destination of the user through the application based on user's contextual information. The user terminal may provide vacant seat information in a cabin through the application.

2) Cabin Interior Layout Countermeasure Scenario

A second scenario S112 is a cabin interior layout countermeasure scenario. The cabin system 300 may further include a scanning device for acquiring data on the user located outside a vehicle 300. The scanning device scans the user and can obtain physical data and baggage data of the user. The physical data and baggage data of the user can be used to set the layout. The physical data of the user can be used for user authentication. The scanning device can include at least one image sensor. The image sensor can use light in a visible light band or an infrared band to acquire an image of the user.

The seat system 360 can set the layout in the cabin based on at least one of the physical data and baggage data of the user. For example, the seat system 360 may provide a baggage loading space or a seat installation space.

3) User Welcome Scenario

A third scenario S113 is a user welcome scenario. The cabin system 300 may further include at least one guide light. The guide light may be disposed on a floor in the cabin. The cabin system 300 may output the guide light such that the user is seated on the seat, which is already set among the plurality of sheets when user's boarding is detected. For example, a main controller 370 may implement moving light through sequential lighting of a plurality of light sources according to the time from an open door to a predetermined user seat.

4) Seat Adjustment Service Scenario

A fourth scenario S114 is a seat adjustment service scenario. The seat system 360 may adjust at least one element of the seat that matches the user based on the acquired physical information.

5) Personal Content Provision Scenario

A fifth scenario S115 is a personal content provision scenario. A display system 350 can receive personal data of the user via an input device 310 or a communication device 330. The display system 350 can provide a content corresponding to the personal data of the user.

6) Product Provision Scenario

A sixth scenario S116 is a product provision scenario. A cargo system 355 can receive user data through the input device 310 or the communication device 330. The user data may include preference data of the user and destination data of the user. The cargo system 355 may provide a product based on the user data.

7) Payment Scenario

A seventh scenario S117 is a payment scenario. A payment system 365 can receive data for price calculation from at least one of the input device 310, the communication device 330 and the cargo system 355. The payment system 365 can calculate a vehicle usage price of the user based on the received data. The payment system 365 can require the user (that is, mobile terminal of user) to pay a fee at the calculated price.

8) User Display System Control Scenario

An eighth scenario S118 is a user display system control scenario. The input device 310 may receive a user input configured in at least one form and may convert the user input into an electrical signal. The display system 350 can control a content displayed based on the electrical signal.

9) AI Agent Scenario

A ninth scenario S119 is a multi-channel artificial intelligence (AI) agent scenario for multiple users. An AI agent 372 can distinguish the user input of each of multiple users. The AI agent 372 can control at least one of the display system 350, the cargo system 355, the seat system 360, and the payment system 365 based on the electric signal converted from the user input of each of the multiple users.

10) Multimedia Content Provision Scenario for Multiple Users

A tenth scenario S120 is a multimedia content provision scenario for multiple users. The display system 350 can provide a content that all users can view together. In this case, the display system 350 can individually provide the same sound to multiple users through a speaker provided in each sheet. The display system 350 can provide a content that the multiple users individually can view. In this case, the display system 350 can provide an individual sound through the speaker provided in each sheet.

11) User Safety Securing Scenario

An eleventh scenario S121 is a user safety securing scenario. When vehicle peripheral object information that poses a threat to the user is acquired, the main controller 370 can control to output an alarm of the vehicle peripheral object via the display system 350.

12) Belongings Loss Prevention Scenario

A twelfth scenario S122 is a scenario for preventing loss of belongings of the user. The main controller 370 can obtain data on the belongings of the user via the input device 310. The main controller 370 can obtain user motion data through the input device 310. The main controller 370 can determine whether the user places the belongings and gets off based on the data of the belongings and the motion data. The main controller 370 can control to output an alarm of the belongings through the display system 350.

13) Get Off Report Scenario

A thirteenth scenario S123 is a get off report scenario. The main controller 370 can receive get off data of the user through the input device 310. After the user gets off, the main controller 370 can provide report data for the get off to the mobile terminal of the user through the communication device 330. The report data may include the entire usage fee data of the vehicle 10.

Vehicle-to-Everything (V2X)

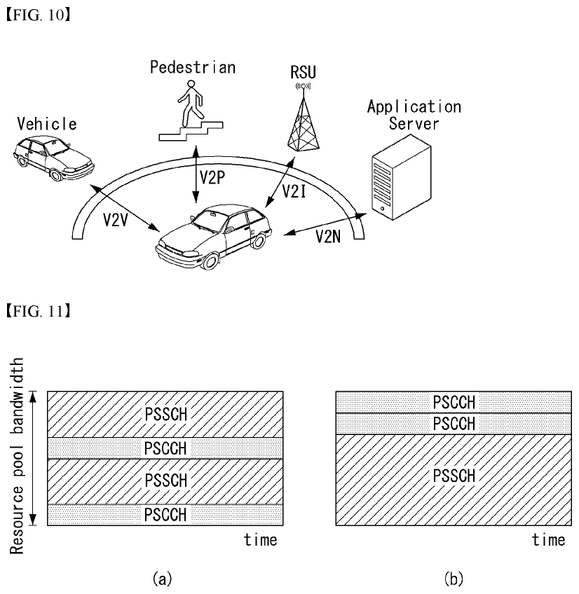

FIG. 10 is an example of V2X communication to which the present disclosure is applicable.

The V2X communication includes communication between a vehicle and all objects such as Vehicle-to-Vehicle (V2V) referring to communication between vehicles, Vehicle-to-Infrastructure (V2I) referring to communication between a vehicle and an eNB or a Road Side Unit (RSU), and Vehicle-to-Pedestrian (V2P) or a Vehicle-to-Network (V2N) referring to communication between a vehicle and a UE with an individual (pedestrian, bicycler, vehicle driver, or passenger).

The V2X communication may indicate the same meaning as V2X side-link or NR V2X, or may include a broader meaning including the V2X side-link or NR V2X.

For example, the V2X communication can be applied to various services such as forward collision warning, an automatic parking system, a cooperative adaptive cruise control (CACC), control loss warning, traffic matrix warning, traffic vulnerable safety warning, emergency vehicle warning, speed warning on a curved road, or a traffic flow control.

The V2X communication can be provided via a PC5 interface and/or a Uu interface. In this case, in a wireless communication system that supports the V2X communication, there may exist a specific network entity for supporting the communication between the vehicle and all the objects. For example, the network object may be a BS (eNB), the road side unit (RSU), a UE, an application server (for example, a traffic safety server), or the like.

In addition, the UE executing V2X communication includes not only a general handheld UE but also a vehicle UE (V-UE), a pedestrian UE, a BS type (eNB type) RSU, a UE type RSU, a robot having a communication module, or the like.

The V2X communication may be executed directly between UEs or may be executed through the network object(s). V2X operation modes can be divided according to a method of executing the V2X communication.

The V2X communication requires a support for UE pseudonymity and privacy when a V2X application is used so that an operator or a third party cannot track a UE identifier within a V2X support area.

Terms frequently used in the V2X communication are defined as follows.
Road Side Unit (RSU): The RSU is a V2X serviceable device that can perform transmission/reception with a moving vehicle using a V2I service. Furthermore, the RSU can exchange messages with other entities supporting the V2X application as a fixed infrastructure entity supporting the V2X application. The RSU is a term often used in the existing ITS specifications, and a reason for introducing this term in 3GPP specifications is to make it easy to read a document in an ITS industry. The RSU is a logical entity that combines a V2X application logic with functions of a BS (referred to as BS-type RSU) or a UE (referred to as UE-type RSU).
V2I service: A type of V2X service in which one is a vehicle and the other is an entity belongs to an infrastructure.
V2P service: A type of the V2X service in which one is a vehicle and the other is a device (for example, handheld UE carried by pedestrian, bicycler, driver, or passenger) carried by an individual.
V2X service: A 3GPP communication service type in which a transmitting or receiving device is related to a vehicle.
V2X enabled UE: A UE supporting the V2X service.
V2V service: A type of the V2X service in which both in the communication are vehicles.
V2V communication range: A range of direct communication between two vehicles participating in the V2V service.

As described above, the V2X application referred to as the V2X (Vehicle-to-Everything) includes four types such as (1) Vehicle-to-Vehicle (V2V), (2) Vehicle-to-infrastructure (V2I), (3) Vehicle-to-Network (V2N), and (4) Vehicle-to-Pedestrian (V2P).

FIG. 11 shows a resource allocation method in a side-link where the V2X is used.

In the side-link, different physical side-link control channels (PSCCHs) may be separately allocated in a frequency domain, and different physical side-link shared channels (PSSCHs) may be separately allocated. Alternatively, different PSCCHs may be allocated consecutively in the frequency domain, and PSSCHs may also be allocated consecutively in the frequency domain.

NR V2X

In order to extend a 3GPP platform to a vehicle industry during 3GPP release 14 and 15, supports for the V2V and V2X services are introduced in LTE.

Requirement for supports with respect to an enhanced V2X use case are broadly divided into four use case groups.

(1) A Vehicle Platooning can dynamically form a platoon in which vehicles move together. All vehicles in the platoon get information from the top vehicle to manage this platoon. These pieces of information allow the vehicles to be operated in harmony in the normal direction and to travel together in the same direction.

(2) Extended sensors can exchange raw data or processed data collected by a local sensor or a live video image in a vehicle, a road site unit, a pedestrian device, and a V2X application server. In the vehicle, it is possible to raise environmental awareness beyond what a sensor in the vehicle can sense, and to ascertain broadly and collectively a local situation. A high data transmission rate is one of main features.

(3) Advanced driving allows semi-automatic or full-automatic driving. Each vehicle and/or the RSU shares own recognition data obtained from the local sensor with a proximity vehicle and allows the vehicle to synchronize and coordinate a trajectory or maneuver. Each vehicle shares a driving intention with the proximity vehicle.

(4) Remote driving allows a remote driver or the V2X application to drive the remote vehicle for a passenger who cannot drive the remote vehicle in his own or in a dangerous environment. If variability is restrictive and a path can be forecasted as public transportation, it is possible to use Cloud computing based driving. High reliability and a short waiting time are important requirements.

Main Embodiments of the Present Disclosure

The 5G communication technology described above can be applied in combination with methods according to the present disclosure to be described later, or can be supplemented to specify or clarify the technical features of methods described in the present disclosure. A control method of an autonomous vehicle described in the present disclosure can be applied in combination with communication services according to 3G, 4G and/or 6G communication technologies in addition to the 5G communication technology described above.

The beam management technology described above can be applied in combination with methods according to the present disclosure to be described later. Among the contents mentioned in relation to the beam management, functions/operations of a base station (BS) can be performed by a Tx UE, a Tx vehicle (first vehicle below), or an autonomous vehicle. Among the contents mentioned in relation to the beam management, functions/operations of a user equipment (UE) can be performed by a Rx UE, a Rx vehicle (second vehicle below), or a target vehicle, and is not necessarily limited thereto.

In the following description, all the Tx UE, the Tx vehicle, the first vehicle, and the autonomous vehicle may include the same component and perform the same function. In the following description, all the Rx UE, the Rx vehicle, the second vehicle, and the target vehicle may include the same component and perform the same function.

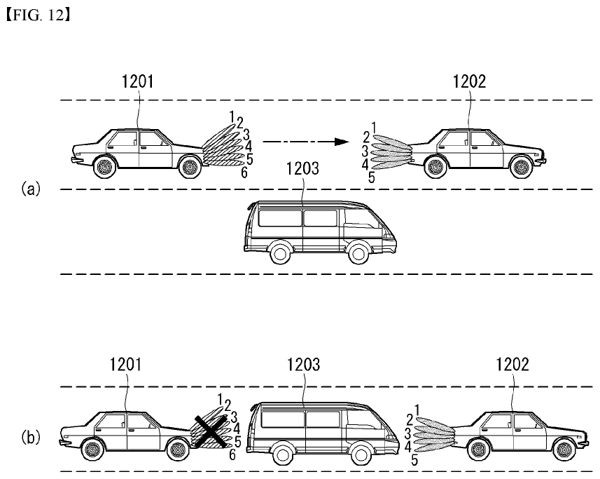

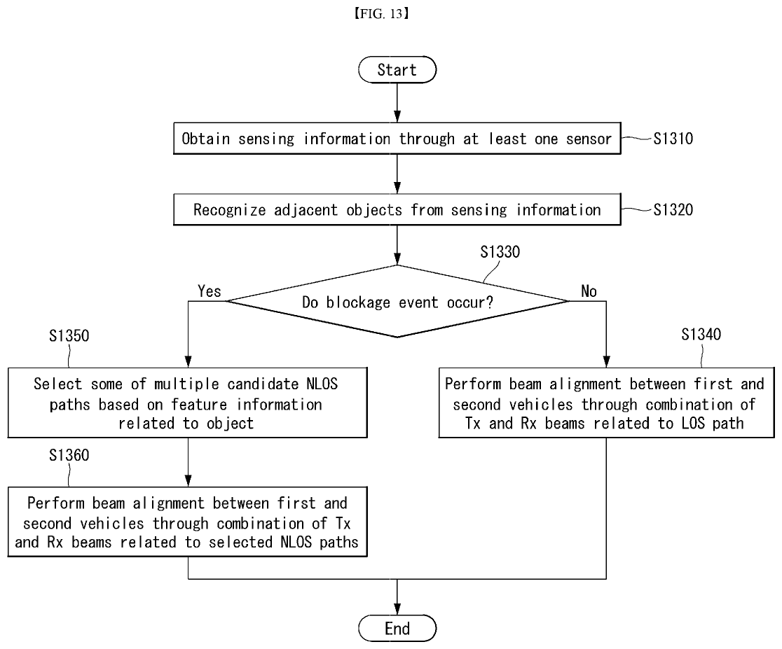

FIG. 12 illustrates an example diagram for explaining why a blockage by a blocker during above 6 GHz communication is a problem. The above 6 GHz communication includes mmWave communication and THz communication. Hereinafter, although the present disclosure is described taking the mmWave communication as an example, the present disclosure is not limited thereto. In other words, in the following description, the THz communication can be used as the same manner as the mmWave communication.

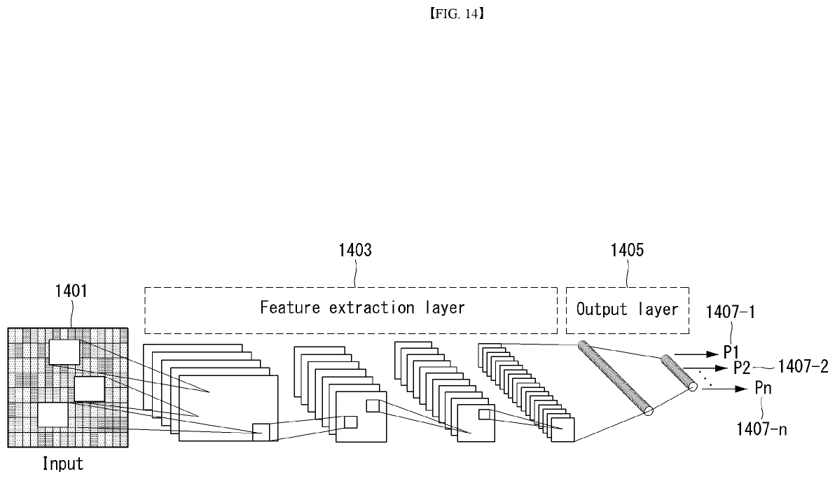

First, before performing at least one step illustrated in FIG. 13, an autonomous vehicle establishes a communication connection with a target vehicle through one of the following first to fourth examples.

As the first example, the autonomous vehicle may establish (initiate) a communication connection with the target vehicle using discovery technology of Long Term Evolution (LTE). That is, the autonomous vehicle may initiate mmWave (5G) communication using discovery technology of LTE device to device (D2D) communication and/or vehicle to X (V2X) communication. For example, in the LTE D2D/V2X technology, the autonomous vehicle (Tx UE) and/or the target vehicle (Rx UE) are/is allocated a resource pool (radio frequency/time resource) for each ID of services (e.g., sensor data exchange service and forward traffic condition data sharing service using mmWave) pre-allocated from the base station/network. The Tx UE and/or the Rx UE may periodically discover nearby UEs using the allocated resource pool.

When two UEs recognize each other after the discovery procedure, the two UEs may initiate the mmWave communication. Specifically, the Tx UE that is a preceding vehicle of the Rx UE may transmit a collision warning message to the Rx UE, that is a following vehicle of the Tx UE, using the resource pool so as to share forward traffic condition data. In the same manner as this, the Rx UE receives the collision warning message using the resource pool. The Rx UE may transmit a response message to the Tx UE in the same manner. In this way, the Tx UE and the Rx UE may discover the counterpart UE.

Based on the Tx UE receiving the response message after the discovery procedure, the Tx UE may transmit a Tx Beam for beam pairing to the Rx UE via mmWave, and share the forward traffic condition data with the Rx UE through the Tx Beam.

As the second example, the autonomous vehicle may initiate the communication connection with the target vehicle by mixing a user interface (UI) and the existing communication technology. The autonomous vehicle may select a specific vehicle, that wants to initiate communication, based on a driver's selection using the UI in the autonomous vehicle. For example, the autonomous vehicle may acquire the driver's selection using the UI by a user touching the specific vehicle on a UI screen provided in the autonomous vehicle, by recognizing a voice of the user uttering a vehicle number of the specific vehicle, by obtaining a gesture indicating the specific vehicle from the user, by the user pointing to the specific vehicle on AR/VR, or by recognizing that the user has uttered features (e.g., a black car) of the specific vehicle. As described above, when the autonomous vehicle acquires the driver's selection, the autonomous vehicle may use an artificial intelligence technology to select a specific target vehicle. The autonomous vehicle may identify the specific target vehicle using a license plate of the target vehicle or QR code information related to the target vehicle. For example, the autonomous vehicle may detect the QR code information of the target vehicle in infrared/visible light areas. For example, the QR code information of the target vehicle may be attached to the surface of the target vehicle.

As described above, after the autonomous vehicle identifies the target vehicle, the autonomous vehicle may initiate the mmWave communication with the selected target vehicle using the existing communication technology. For example, the autonomous vehicle may transmit vehicle identification information to the selected target vehicle through an LTE call, and the selected target vehicle may initiate the mmWave communication with the autonomous vehicle among surrounding vehicles.

As the third example, the autonomous vehicle may initiate communication connection using mmWave technology. First, each of the autonomous vehicle (Tx UE) and the target vehicle (Rx UE) may discover an opposing vehicle based on a predefined period using a frequency/time radio resource of mmWave band assigned to each ID of predefined services (e.g., sensor data exchange service, traffic condition sharing service, etc.) before the mmWave communication. For example, when the autonomous vehicle precedes the target vehicle and selects the target vehicle through the second example above, the autonomous vehicle may transmit the Tx beam for beam-pairing of mmWave to the target vehicle if the mmWave communication period is reached.

Subsequently, the target vehicle (Rx UE) may measure a plurality of candidate beams 1, 2, 3, 4, 5 and 6 and select a transmit (Tx) beam representing a largest signal among the measured candidate beams. The target vehicle may transmit a signal or message related to an identification number of the selected transmit beam to the Tx UE.

Next, the Tx UE may detect the signal or message of the Rx UE and initiate communication with the Rx UE.

As the fourth example, the autonomous vehicle may initiate communication connection with the target vehicle using the discovery and a vehicle list. Specifically, the Tx UE and the Rx UE may receive, from a server/network, a list of vehicles capable of performing mmWave communication among nearby vehicles using the existing communication technology, i.e., the discovery technology of LTE D2D/V2X communication or the discovery technology of 5G NR. For example, when the list of vehicles is received, an UI of the autonomous vehicle may display a vehicle candidate. The UI may represent vehicle information in various UI forms, and the driver may select one vehicle among them. Thereafter, the autonomous vehicle may initiate communication connection with the vehicle selected by the driver via the UI.

Referring again to FIG. 12, (a) of FIG. 12 illustrates an example of performing mmWave communication between a Tx UE 1201 and an Rx UE 1202. The Tx UE 1201 and the Rx UE 1202 communicate with each other based on one of the first to fourth examples described above.

(a) of FIG. 12 illustrates an example of sidelink communication performed in a beamforming technique. The Tx UE 1201 may be configured to transmit at least one of beams toward the Rx UE 1202. For example, the Tx UE 1201 may sweep or transmit a signal in eight directions using eight slots (e.g., antenna port(s)) during a synchronization slot. Here, each direction has a corresponding Tx beam index.

The Rx UE 1202 may determine or select a strongest (e.g., strongest signal) or preferred beam or beam index among the beams transmitted by the Tx UE 1201.

For example, the Rx UE 1202 may transmit a reference signal or a SideLink Synchronization Signal (SLSS)/Physical Sidelink Broadcast Channel (PSBCH) block in multiple directions from the Tx UE 1201 in a beam sweeping method. In this instance, the reference signal or the SLSS/PSBCH block may be transmitted in omni-direction or multiple predefined directions. The Rx UE 1202 may receive the reference signal or the SLSS/PSBCH block from the Tx UE 1201 and measure a quality (e.g., received signal strength) of the received reference signal or SLSS/PSBCH block. The Rx UE 1202 may transmit, to the Tx UE 1201, information indicating an index (e.g., Tx beam index) of a beam through which the reference signal or the SLSS/PSBCH block with the best quality is transmitted. And, the Tx UE 1201 may transmit the reference signal or the SLSS/PSBCH block using a Tx beam indicated by the information received from the Rx UE 1202.

The Rx UE 1202 may also receive the reference signal or the SLSS/PSBCH block based on the beam sweeping method.

For example, the Rx UE 1202 may receive the reference signal or the SLSS/PSBCH block in each of a plurality of reception directions by adjusting a reception direction and may measure a quality (e.g., received signal strength) of the received reference signal or SLSS/PSBCH block. The Rx UE 1202 may determine, as a final reception direction (e.g., Rx beam), a reception direction in which the reference signal or the SLSS/PSBCH block with the best quality is received among a plurality of reception directions. The Rx UE 1202 may inform the base station for the determined final reception direction.

As described above, an optimal beam pair (i.e., reception direction) between the Tx UE 1201 and the Rx UE 1202 may be configured by performing at least one operation for determining the above-described Tx beam and Rx beam.

(b) of FIG. 12 illustrates an example where a blocker 1203 is positioned on a line of sight (LOS) path of the Tx UE 1201 and the Rx UE 1202 and interferes with mmWave communication.

Referring to (b) of FIG. 12, a blocker may be positioned between the existing LOS paths of the Tx UE 1201 and the Rx UE 1202. Exemplarily, there frequently occurs a situation in which another vehicle 1203 enters between two vehicles while multiple vehicles are driving to change its lane. In this instance, if the two vehicles are performing mmWave communication, the two vehicles, which serve as the Tx UE 1201 and the Rx UE 1202 based on the property of above 6 GHz-based communication with strong linearity and communicate with each other, will no longer be able to transmit and receive data.

When the blocker 1203 is positioned between the Tx UE 1201 and the Rx UE 1202 as described above, the Tx UE 1201 and the Rx UE 1202 may perform communication to bypass the blocker 1203 using an NLOS path in addition to the LOS path. Hereinafter, the present disclosure describes an mmWave communication method through the NLOS path by bypassing the blocker 1203. Specifically, the present disclosure describes various embodiments of sensing the blocker 1203 and efficiently configuring beam pair based on the sensed blocker 1203. Furthermore, the present disclosure describes various embodiments of providing a timing advance (TA) value and a size of an Rx window dynamically adapted to a distance change caused by the blocker 1203.

As described above, various embodiments of the present disclosure can provide optimal above 6 GHz wireless communication service based on various sensing information of a driving environment regardless of the blocker 1203.

FIG. 13 is a flow chart illustrating a wireless communication method of a vehicle UE according to an embodiment of the present disclosure.

At least one operation of FIG. 13 may be performed by at least one processor included in a vehicle. Some operations of FIG. 13 may be performed by at least one processor included in a communication system including a UE or a base station connected via a network. In the following description, the Tx UE may be defined as a first UE or a first vehicle, and the Rx UE may be defined as a second UE or a second vehicle.

Referring to FIG. 13, the first vehicle may obtain sensing information through at least one sensor, in S1310.

The first vehicle may include at least one sensor for obtaining the sensing information. For example, at least one sensor may include a lidar and/or a radar. For another example, at least one sensor may further include a camera, and in this instance, the sensing information may further include an image.

One or more Tx beam indexes may be predefined in the sensing information used in various embodiments of the present disclosure. For example, a direction of a directional beam may be predefined, and a plurality of predefined directions respectively corresponds to Tx beam indexes. That is, the Tx beam indexes related to the plurality of directions are mapped to the sensing information.

As above, based on the sensing information mapped to the Tx beam indexes, the first vehicle may check various moving objects and still objects positioned around the first vehicle in real time or periodically to adaptively select the Tx beam to an image.

Above 6 GHz communication of 5G NR or 6G requires a large number of antenna elements to secure high directivity. When the number of antenna elements is increased, a beam width is reduced. Further, more beam combinations shall be considered when aligning beams, and at the same time, the mobility of the UE becomes very sensitive.

In various embodiments of the present disclosure, the first vehicle may determine the beam pair by selecting some of a plurality of beam indexes using the sensing information mapped to the beam indexes described above. A selection process of the beam pair will be described with reference to the following operations.

The first vehicle may detect one or more adjacent objects from the sensing information, in S1320.

In some embodiments of the present disclosure, the first vehicle may detect at least one object using an object tracking technique using a ray tracing technique or a convolutional neural network (CNN). The object tracking technique using the ray tracing technique and the CNN is known in the technical field related to a computer vision, and thus a detailed description thereof is omitted.

The at least one object may be an object adjacent to the first vehicle.

The at least one object may include other vehicles, buildings, pedestrians, trees, and the like, but is not limited thereto. Thereafter, when a plurality of objects is detected, at least some of the plurality of objects may be classified as blockers.

At least some of the plurality of objects may be classified as blockers, and remaining some may be classified as reflectors or refractors. The reflectors or the refractors mean an intermediate object that avoids the blockers and performs communication. The first vehicle may communicate through the NLOS path by the reflector or the refractor when it cannot communicate through the LOS path.

The first vehicle may check occurrence of a blockage event where a blocker on a line of sight (LOS) path blocks the second vehicle, in S1330.

The blocker means an object that is positioned between the first vehicle and the second vehicle and blocks the LOS path. For example, the blocker includes other vehicles, buildings, pedestrians, trees, and the like, but is not limited thereto.

In other words, when there occurs an event (i.e., a blockage event) where the second vehicle, which has been detected through at least one sensor, is no longer detected due to another object, the at least one processor may set an object blocking the second vehicle as a blocker.

For example, when a specific object is positioned between the first and second vehicles and the second vehicle is no longer detected through at least one sensor, the specific object may be annotated as a blocker. In other words, when a blockage event occurs by at least one of the one or more objects detected in advance, the at least one processor may set one or more objects related to the occurrence of the event as blockers and may set one or more remaining objects unrelated to the occurrence of the event as reflectors or refractors.

Thereafter, the at least one processor may control a transceiver so that it performs beam tracking while avoiding the blockers. Such a control operation is performed while the second vehicle is not detected. When the blockage event ends, the at least one processor may control the transceiver so that it aligns the beams through the LOS path as in S1340.

If the blockage event does not occur (‘No’ in S1330), the first vehicle may perform beam alignment with the second vehicle through the LOS path, in S1340.

In an embodiment, the first vehicle may find an optimal beam pair through the LOS path not through a reflected wave path. As above, the first vehicle may selectively use a method of using the LOS path or the NLOS path depending on whether the blocker is present or absent. Specifically, when the blockage event occurs, the communication is performed through the NLOS path, and when the blocker is not present, the communication is performed through the LOS path.

If the blockage event occurs (Yes' in S1330), the first vehicle may select some of a plurality of candidate NLOS paths based on feature information of an object related to the NLOS path, in 51350.

In an embodiment, the at least one processor may extract feature information related to the object from an image acquired through the camera. The feature information may be extracted by a machine learning network. The machine learning network may include a graph neural network (GNN) or a convolutional neural network (CNN), but is not limited thereto.

For example, in a GNN based process, the at least one processor performs object recognition using feature points of at least one object included in the image and an edge defined by a relationship between the feature points. For another example, in a CNN based process, the at least one processor may extract feature information from the image using at least one convolutional layer or at least one deconvolutional layer. The feature information may be extracted in the form of a feature map or feature value.

In some embodiments, the machine learning network is a model trained, as training data, on a dataset that sets an image including an object related to the NLOS path as an input and sets the success probability of beam alignment as an output.

In other some embodiments, the machine learning network is a model trained, as training data, on a dataset that extracts predefined feature information from an image including an object related to the NLOS path to set the extracted feature information as an input and sets the success probability of beam alignment as an output.

The at least one processor may predict the success probability of beam alignment from the image acquired through the camera using the pre-trained machine learning network as described above. This prediction is performed based on the input and the output of the training data of the machine learning network described above. In this instance, the success probability of beam alignment may be calculated for each of a plurality of NLOS paths.

Thereafter, in some embodiments, the at least one processor may compare probability values calculated for each NLOS path to select one of the NLOS paths. Specifically, the NLOS path corresponding to a maximum probability among the calculated probability values may be selected.

In other some embodiments, the at least one processor may select at least some of the probability values calculated for each NLOS path. For example, the at least one processor may sort the calculated probability values in descending order to select the top N NLOS paths. For another example, the at least one processor may compare the calculated probability values with a threshold value to select at least one NLOS path in which the probability value exceeds the threshold value.

The first vehicle may perform beam alignment between the first and second vehicles through a Tx-Rx beam combination related to the selected NLOS path, in S1360.

When the NLOS path is selected, it is possible to specify a Tx beam and an Rx beam forming the selected NLOS path. The at least one processor may perform beam training through a combination of the Tx beam and the Rx beam related to one or more selected NLOS paths.

Specifically, the first vehicle may transmit a plurality of candidate beams in a direction corresponding to a Tx beam index related to the NLOS path. In this instance, the first vehicle may request, from the second vehicle, information related to a reception strength of each of the plurality of candidate beams in the second vehicle and may receive, from the second vehicle, the information related to the reception strength of each of the plurality of candidate beams.

Subsequently, the first vehicle may check a candidate beam having the largest reception strength in the second vehicle among the plurality of candidate beams.

Subsequently, the first vehicle may select a specific candidate beam from among the plurality of candidate beams as an optimal beam and transmit data to the second vehicle through the specific candidate beam.

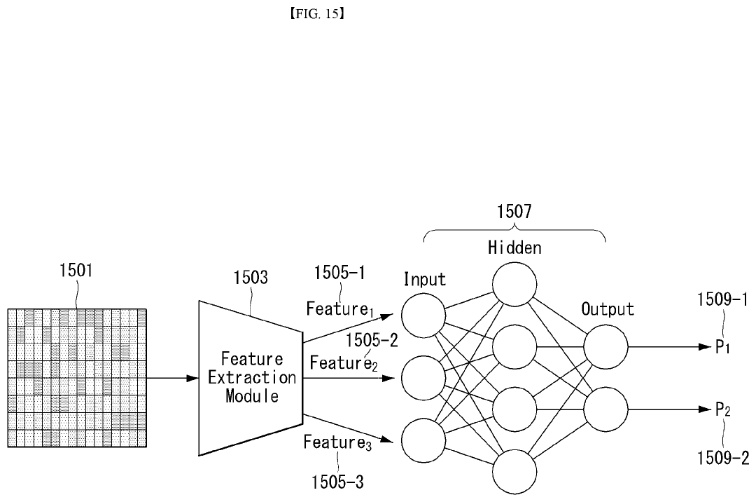

FIG. 14 is an example diagram for explaining a vision recognition process using a convolutional neural network applied to some embodiments of the present disclosure. FIG. 15 is an example diagram for explaining a vision recognition process using a convolutional neural network applied to other some embodiments of the present disclosure.

Referring to FIG. 14, a machine learning network applied to some embodiments of the present disclosure may be implemented by a convolutional neural network including a feature extraction layer 1403 and an output layer 1405. The feature extraction layer 1403 may include a convolutional layer and may optionally further include various layers, such as a pooling layer. In such a case, the machine learning network may extract feature data (e.g., feature map) from an input image 1401 through the feature extraction layer 1403 and may calculate at least one prediction value (1407-1, 1407-2, . . . , 1407-n) based on the feature data through the output layer 1405.

The convolutional neural network is a neural network specialized in image recognition. Therefore, according to some embodiments of the present disclosure, an effect of identification on at least one object included in the input image 1401 can be further improved by utilizing characteristics of the convolutional neural network specialized in an image. The machine learning network may be implemented through various machine learning models in addition to the convolutional neural network described above.

Referring to FIG. 15, in other some embodiments of the present disclosure, predefined features 1505-1, 1505-2, and 1505-3 in an input image 1501 may be extracted, and a machine learning network 1507 may calculate at least one prediction value (1509-1 and 1509-2) based on the predefined features 1505-1, 1505-2, and 1505-3. That is, in embodiments of the present disclosure, the machine learning network 1507 does not automatically extract the features from the input image 1501, and the predefined features 1505-1, 1505-2, and 1505-3 are used. The predefined features 1505-1, 1505-2, and 1505-3 may include style information of the image (e.g., various statistical information such as average and standard deviation), pixel value patterns, statistical information of pixel values, and the like. In addition, the predefined features may further include features well known in the art, such as Scale Invariant Feature Transform (SIFT), Histogram of Oriented Gradient (HOG), Haar, and Local Binary Pattern (LBP).

Referring again to FIG. 15, a feature extraction module 1503 may extract at least one of the exemplified features 1505-1, 1505-2, and 1505-3 from the input image 1501, and the extracted features 1505-1, 1505-2, and 1505-3 may be input to the machine learning network 1507. The machine learning network 1507 may output the prediction values 1509-1 and 1509-2 based on the input features 1505-1, 1505-2, and 1505-3. FIG. 15 illustrates that the machine learning network 1507 is implemented by an artificial neural network (ANN), by way of example, but the present disclosure is not limited thereto. For example, the machine learning network 1507 may be implemented based on a traditional machine learning model, such as a support vector machine (SVM). According to embodiments of the present disclosure, the appropriate prediction values 1509-1 and 1509-2 may be calculated based on the main features 1505-1, 1505-2, and 1505-3 stored by the user.

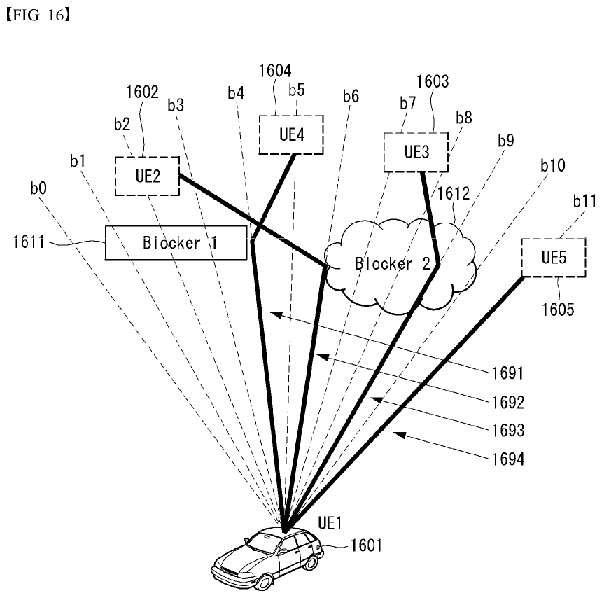

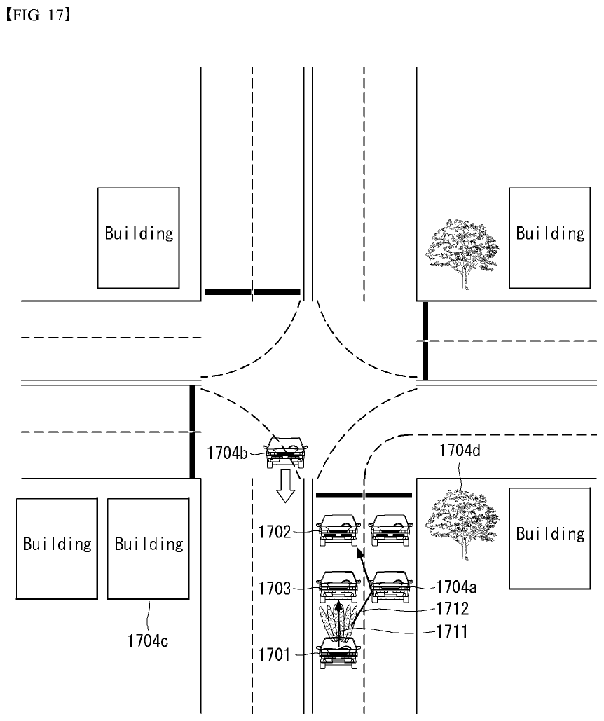

FIG. 16 is an example diagram of a machine learning based beam tracking method applied to various embodiments of the present disclosure.

As illustrated in FIG. 16, a first vehicle 1601 performs wireless communication (e.g., mmWave communication, THz communication, etc.) with a second vehicle 1602 and may be obstructed by a blocker while driving.

In an embodiment, the blocker may include a reflector and a refractor. Referring to FIG. 16, a first blocker (Blocker 1) 1611 indicates the reflector, and a second blocker (Blocker 2) 1612 indicates the refractor.

FIG. 16 illustrates a first vehicle 1601 that performs beam tracking using a plurality of candidate beams. The first vehicle 1601 may perform beam tracking using candidate beams b0 to b11, and second to fifth vehicles 1602 to 1605 illustrate vehicles performing above 6 GHz communication with the first vehicle 1601, by way of example. First to third paths illustrate NLOS paths related to the first and second blockers 1611 and 1612, by way of example, and various embodiments of the present disclosure are not limited to the assumption of FIG. 16.

The first vehicle 1601 may generate a first NLOS path 1691 in a relationship with the first blocker 1611. The first NLOS path 1691 corresponds to the beam b4 among the plurality of candidate beams of the first vehicle 1601. That is, the beam b4 may be reflected by the first blocker 1611 and transmitted to the fourth vehicle 1604. Hence, the first vehicle 1601 may communicate with the fourth vehicle 1604 through the first NLOS path 1691.

The first vehicle 1601 may also communicate through an LOS path in addition to the first NLOS path 1691 generated in relation to the first blocker 1611. For example, the first vehicle 1601 may communicate with the fourth vehicle 1604 through an LOS path corresponding to the beam b5.

As describe above, a variety of NLOS paths or LOS paths through which the first vehicle 1601 can communicate with specific vehicles may be provided, and the first vehicle 1601 may select at least some of a plurality of NLOS paths or LOS paths and use them in beam tracking.

The first vehicle 1601 may generate a second NLOS path 1692 in a relationship with the second blocker 1612. The second NLOS path 1692 corresponds to the beam b6 among the plurality of candidate beams of the first vehicle 1601. That is, the beam b6 may be reflected by the second blocker 1612 and transmitted to the second vehicle 1602. Hence, the first vehicle 1601 may communicate with the second vehicle 1602 through the second NLOS path 1692. The present disclosure illustrates that the second blocker 1612 is the refractor, by way of example, but it is known that a beam incident on the refractor at a predetermined angle can be reflected.

The first vehicle 1601 may generate a third NLOS path 1693 in a relationship with the second blocker 1612. The third NLOS path 1693 corresponds to the beam b9 among the plurality of candidate beams of the first vehicle 1601. That is, the beam b9 may be reflected by the second blocker 1612 and transmitted to the third vehicle 1603. Hence, the first vehicle 1601 may communicate with the third vehicle 1603 through the third NLOS path 1693.

The first vehicle 1601 may also communicate through an LOS path 1694 regardless of the first and second blockers 1611 and 1612. For example, the first vehicle 1601 may communicate with the fifth vehicle 1605 through the LOS path 1694 in which there is no blockage event caused by the first and second blockers 1611 and 1612. In this instance, the LOS path corresponds to the beam b11 among the candidate beams.

Referring again to FIG. 16, in the first vehicle 1601, sensing information acquired by at least one sensor may be combined with a plurality of candidate beam indexes. The first vehicle 1601 may select some of the plurality of candidate beams based on the sensing information combined with the candidate beam indexes. Thereafter, some selected beams are selected as candidate beams for beam tracking, and the effective beam tracking can be performed even if all the candidate beams are not used for beam tracking.

In an embodiment, some of the plurality of candidate beams are selected based on a value obtained by probabilistically evaluating the LOS path and/or the NLOS path corresponding to each of the plurality of candidate beams. The machine learning networks described above with reference to FIGS. 14 and 15 may be used for such probabilistic evaluation. The probabilistic evaluation may be composed of high, medium, low, and zero depending on the value.

For example, the first NLOS path 1691 generated by the first vehicle 1601 in relation to the first blocker 1611 may be evaluated as ‘high’ based on information about the first blocker 1611 obtained from an image. Specifically, at least one processor may check NLOS paths related to the first blocker 1611 included in the image and may determine a possibility of communicating with the fourth vehicle 1604 based on the checked NLOS paths. More specifically, at least one processor matches NLOS paths related to the first blocker 1611 to the beams b1, b2, b3, and b4, respectively. Here, the probability that the NLOS paths corresponding to the beams b1, b2, and b3 will communicate with the fourth vehicle 1604 may be evaluated as zero probability considering a direction of the incident beam and an angle of reflection due to the first blocker 1611. However, the probability that the NLOS path corresponding to the beam b4 will communicate with the fourth vehicle 1604 may be evaluated as high probability considering the direction of the incident beam and the angle of reflection due to the first blocker 1611.

The fourth vehicle 1604 may perform beam alignment through the LOS path corresponding to the beam b5 in addition to the NLOS path formed by the first blocker 1611. In this instance, a success probability of beam alignment through the LOS path may be evaluated as high probability.

If a reference probability for being selected as a candidate beam for beam alignment is high probability, at least one processor may select the candidate beams b4 and b5 that are evaluated as high probability in the above example, and may discover an optimal beam.

FIG. 17 is another example diagram of a machine learning based beam tracking method applied to various embodiments of the present disclosure.

FIG. 17 illustrates a machine learning-based beam tracking method applied in a real road environment. Referring to FIG. 17, communication of a first vehicle 1701 is interrupted by a third vehicle 1703 while the first vehicle 1701 communicates with a second vehicle 1702 as a target vehicle. As above, the third vehicle 1703 that interferes with the communication of the first vehicle 1701 is defined as a blocker.

In this instance, the first vehicle 1701 may communicate with the second vehicle 1702 using objects 1704a, 1704b, 1704c, and 1704d positioned in adjacent environments. The objects 1704a, 1704b, 1704c, and 1704d positioned in the adjacent environments may include other stationary vehicle 1704a, other moving vehicle 1704b, a building 1704c, a tree 1704d, and the like. However, the objects 1704a, 1704b, 1704c, and 1704d are limited to those described above, and may include all of objects with a predetermined reflectance.

At least one processor of the first vehicle 1701 may evaluate a success probability of beam alignment with one or more LOS paths 1711 or NLOS paths 1712 through a plurality of predefined candidate beams. Referring again to FIG. 17, the first vehicle 1701 may communicate using the NLOS path 1712 formed through the other stationary vehicle 1704a.

Hence, the first vehicle 1701 cannot perform the communication on the LOS path 1711 due to the third vehicle 1703 in a relationship with the second vehicle 1702 that has communicated with the first vehicle 1701 before the third vehicle 1703 is positioned, but can perform the communication through the NLOS path 1712 formed in a relationship with the other stationary vehicle 1704a.

FIG. 17 illustrates merely an example, and thus the present disclosure is not limited thereto. The first vehicle 1701 may communicate with the second vehicle 1702 through other objects such as the other moving vehicle 1704b, the building 1704c, the tree 1704d, etc. in addition to the other stationary vehicle 1704a based on the probabilistic evaluation of the LOS paths or the NLOS paths.

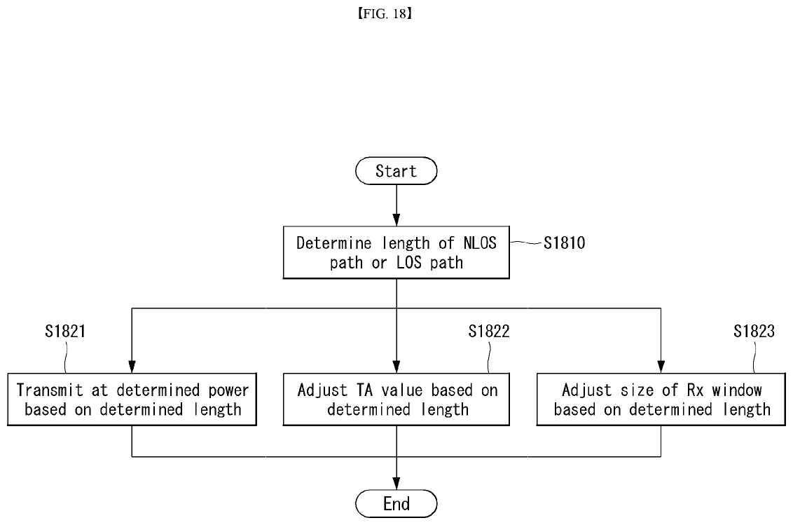

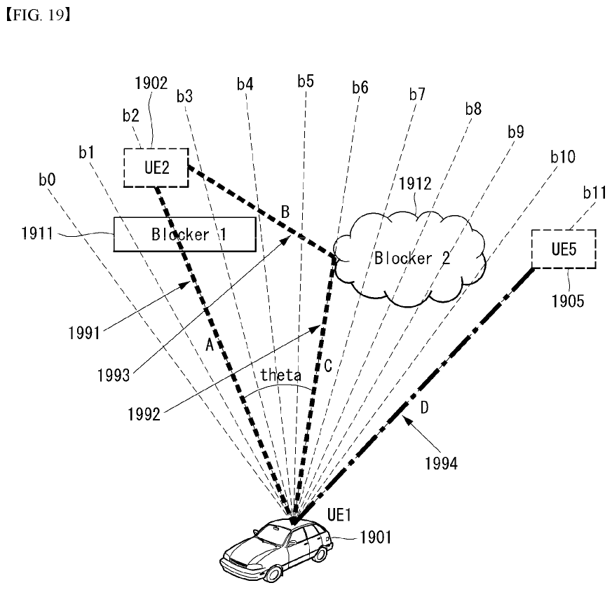

FIG. 18 is a flow chart illustrating a method of adjusting a Tx beam intensity according to an embodiment of the present disclosure.

Referring to FIG. 18, at least one processor of the first vehicle may determine or calculate a distance value of the NLOS path or the LOS path selected through the step S1340 or S1360 described with reference to FIG. 13, in S1810.

The distance value may be calculated based on the obtained sensing information. For example, the distance may be measured using a stereo image generated by at least one camera of the first vehicle, or the distance may be predicted through a pre-trained CNN-based distance estimation module stored in a memory. Further, the first vehicle may directly measure the distance value via lidar or radar.

When the target vehicle is located behind a blocker and the first vehicle communicates with the target vehicle through the NLOS path, a method of calculating the distance value of the NLOS path may be problematic. Specifically, the first vehicle may predict or obtain a first distance between the first vehicle and the second vehicle, and may sense or measure a second distance between the first vehicle and the blocker forming the NLOS path. The first distance may be predicted based on a location, a movement direction, and a movement speed of the second vehicle before a blockage event occurs, or may be extracted from map data including location information of the second vehicle. The second distance may be sensed or measured through at least one sensor (e.g., lidar, radar).

However, the first vehicle does not know a value of a third distance from a reflection point of the blocker to the target vehicle. In this instance, the at least one processor of the first vehicle may predict a third distance between the blocker and the second vehicle using trigonometry to be described in FIG. 19.

The at least one processor of the first vehicle may transmit at a determined power based on the determined length, in S1821. The at least one processor of the first vehicle may adjust a Tx timing advance (TA) value based on the determined distance, in S1822. The at least one processor of the first vehicle may adjust a size of Rx window based on the determined distance, in S1823.

In an embodiment, the at least one processor may perform all the steps S1821, S1822, and S182, or perform at least some of the steps S1821, S1822, or S1823.

As above, in an embodiment, the first vehicle may transmit a beam or signal with power to overcome path attenuation based on the distance value of the selected LOS path or NLOS path.

In addition, in an embodiment, the first vehicle may perform synchronization based on the distance value of the selected LOS path or NLOS path.

FIG. 19 illustrates an example of a method of adjusting a Tx beam intensity applied to an embodiment of the present disclosure. In particular, FIG. 19 illustrates a process of predicting a distance between a blocker and a target vehicle using trigonometry.

Referring to FIG. 19, communication with a first vehicle 1901 is interrupted by a first blocker 1911 while the first vehicle 1901 communicates with a second vehicle 1902. The first vehicle 1901 may communicate with the second vehicle 1902 using a second blocker 1912, that is an adjacent object, based on the various embodiments described above with reference to FIG. 13. A detailed algorithm is omitted since it overlaps with the description described above with reference to FIG. 13.

In an embodiment, the first vehicle 1901 may predict or obtain a first distance 1991 between the first vehicle 1901 and the second vehicle 1902, and may sense or measure a second distance 1992 between the first vehicle 1901 and the blocker forming the NLOS path. The first distance 1991 may be predicted using a probabilistic model based on a position, a movement direction, and a movement speed of the second vehicle 1902 before a blockage event occurs, or may be extracted from map data including location information of the second vehicle 1902. The second distance 1992 may be sensed or measured through at least one sensor (e.g., lidar, radar).

At least one processor of the first vehicle 1901 may estimate a third distance 1993 from a reflection point of the second blocker 1912 to the second vehicle 1902 based on the first and second distances 1991 and 1992. Specifically, at least one processor may estimate the distance through trigonometry using angles formed by the first and second distances 1991 and 1992 and direction vectors of the first and second distances 1991 and 1992.

In an embodiment, if the blockage event does not occur, the first vehicle 1901 may obtain a distance value 1994 of the LOS path based on sensing information acquired through at least one sensor in a relationship with a target vehicle that has communicated with the first vehicle 1901.

That is, in an embodiment, if at least one processor performs communication through the NLOS path, at least one processor can adjust at least one of the Rx power, the TA, or the size of the Rx window based on a distance value of the NLOS path. In addition, in an embodiment, if at least one processor performs communication through the LOS path, at least one processor can adjust at least one of the Rx power, the TA, or the size of the Rx window based on a distance value of the LOS path.

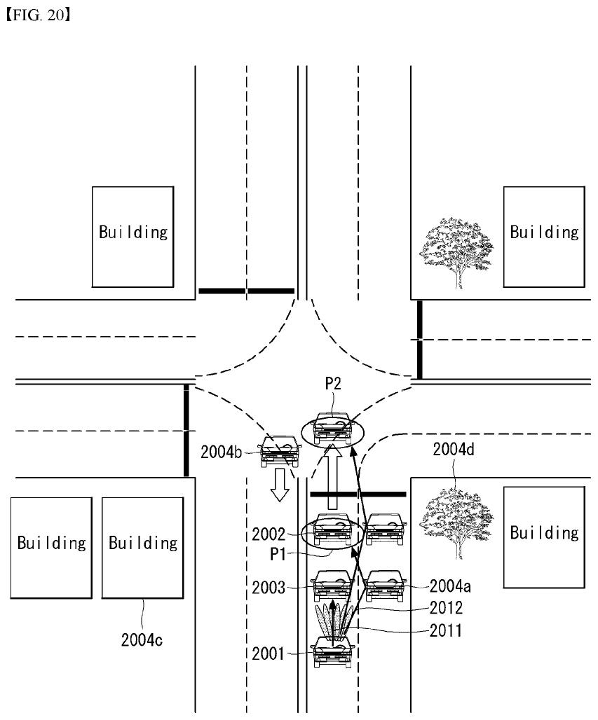

FIG. 20 illustrates another example of a method of adjusting a Tx beam intensity applied to an embodiment of the present disclosure.

FIG. 20 illustrates an example where a blockage event occurs by a third vehicle 2003 while a first vehicle 2001 communicates with a second vehicle 2002 that is a target vehicle. In this instance, an LOS path 2011 previously used for communication connection can no longer be used for mmWave communication.

Unlike FIG. 17, in FIG. 20, the second vehicle 2002 moves from a first position P1 to a second position P2. The following description describes differences in operations according to changes in the position of the second vehicle 2002, and content overlapping with the descriptions in FIGS. 13 to 19 will be omitted.

In an embodiment, at least one processor can adjust at least one of the Rx power, the TA, or the size of the Rx window described above with reference to FIG. 18 dynamically responding to the changed positions.

Referring again to FIG. 20, at least one processor of the first vehicle 2001 may generate one or more NLOS paths or one or more LOS paths based on predefined directions of at least one candidate beam. For example, at least one processor may generate a first NLOS path 2012-1 in a relationship with other first vehicle 2004a-1, and may generate a second NLOS path 2012-1 in a relationship with other second vehicle 2004a-2. In addition to the first and second NLOS paths 2012-1 and 2012-1, more NLOS paths related to the number of candidate beams can be generated, and various embodiments of the present disclosure are not limited to the first and second NLOS paths 2012-1 and 2012-1.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

1. A method of predicting an intelligent beam of an autonomous vehicle in an autonomous driving system, the method comprising:
obtaining sensing information for detecting one or more adjacent objects through at least one sensor of the autonomous vehicle;
in response to an occurrence of a blockage event where a blocker detected on a line of sight (LOS) path between the autonomous vehicle and a target vehicle blocks the target vehicle, selecting some of a plurality of non-line of sight (NLOS) paths between the autonomous vehicle and the target vehicle to continue communication between the autonomous vehicle and the target vehicle; and
selecting an optimal beam related to the target vehicle based on the selected one or more of the plurality of NLOS paths,
wherein the selecting of some of the plurality of NLOS paths is performed based on a pre-trained machine learning network.

2. The method of claim 1, wherein the at least one sensor includes at least one of a lidar, a radar or a camera.

3. The method of claim 1, wherein one or more transmit (Tx) beam indexes are predefined in the sensing information, and
wherein the one or more Tx beam indexes correspond to one or more predefined beam directions.

4. The method of claim 1, wherein the sensing information includes an image including the target vehicle or the one or more adjacent objects.

5. The method of claim 4, wherein the detecting of the one or more adjacent objects in the obtaining of the sensing information comprises detecting the one or more adjacent objects from the image based on a ray tracing technique or a convolutional neural network (CNN).

6. The method of claim 1, wherein the one or more adjacent objects include at least a part of the blocker, a reflector, and a refractor.

7. The method of claim 6, wherein the plurality of NLOS paths include a reflected wave path or a refracted wave path formed by the reflector or the refractor.

8. The method of claim 1,
wherein the pre-trained machine learning network is a sorter trained, as training data, on a dataset that sets an image including an object related an NLOS path from among the plurality of NLOS paths as an input and sets a success probability of a beam alignment as an output.

9. The method of claim 1, wherein the autonomous vehicle and the target vehicle perform above 6 GHz high frequency based communication.

10. The method of claim 1, further comprising:
when the blockage event does not occur, not selecting some of the plurality of NLOS paths and selecting the optimal beam related to the target vehicle based on the LOS path.

11. The method of claim 1, wherein when the blockage event occurs by at least one of the one or more adjacent objects, the at least one adjacent object related to the occurrence of the blockage event is set as the blocker, and remaining one or more adjacent objects unrelated to the occurrence of the blockage event are set as a reflector or a refractor.

12. The method of claim 1, further comprising:
based on the sensing information or map information including the target vehicle, predicting a distance value of some of the plurality of NLOS paths; and
transmitting a beam at a power determined based on the distance value.

13. The method of claim 1, further comprising:
based on the sensing information or map information including the target vehicle, predicting a distance value of some of the plurality of NLOS paths; and
updating a timing advance (TA) value to a value determined based on the distance value.

14. The method of claim 1, further comprising:
based on the sensing information or map information including the target vehicle, predicting a distance value of some of the plurality of NLOS paths; and
updating a size of a receive (Rx) window to a value determined based on the distance value.

15. An autonomous vehicle in a wireless communication system for autonomous driving, the autonomous vehicle comprising:
one or more transceivers;
one or more processors; and
one or more memories connected to the one or more processors and configured to store instructions,
wherein when the instructions are executed by the one or more processors, the instructions cause the one or more processors to execute operations for predicting an intelligent beam, and
wherein the operations comprise:
obtaining sensing information through at least one sensor of the autonomous vehicle;
detecting one or more objects adjacent to the autonomous vehicle;
in response to an occurrence of a blockage event where a blocker detected on a line of sight (LOS) path between the autonomous vehicle and a target vehicle blocks the target vehicle, selecting some of a plurality of non-line of sight (NLOS) paths to be formed between the autonomous vehicle and the target vehicle to continue communication between the autonomous vehicle and the target vehicle; and
selecting an optimal beam related to the target vehicle based on the selected one or more of the plurality of NLOS paths,
wherein the selecting of the optimal beam related to the target vehicle based on the selected one or more of the plurality of NLOS paths is performed based on a pre-trained machine learning network.

16. (canceled)

17. The method of claim 9, wherein the above 6 GHz high frequency based communication includes at least one of mmWave communication and THz communication.

18. The method of claim 1, wherein the optimal beam related to the target vehicle is selected from the some of the plurality of NLOS paths based on an image of the blocker and determination that one of the some of the plurality of NLOS paths provides at least a predetermined probability of communication considering a direction of the optimal beam and an angle of reflection of the optimal beam due to the blocker.

19. A method of using an intelligent beam of an autonomous vehicle in an autonomous driving system, the method comprising:
establishing communication between the autonomous vehicle and a target vehicle using a line of sight (LOS) path;
obtaining sensing information for detecting one or more adjacent objects through at least one sensor of the autonomous vehicle;
detecting a blockage event when a blocker is present in the LOS path between the autonomous vehicle and the target vehicle; and
selecting an optimal beam from among a plurality of non-line of sight (NLOS) paths between the autonomous vehicle and the target vehicle to reestablish communication between the autonomous vehicle and the target vehicle,
wherein the optimal beam is selected based on feature information of the blocker extracted by a machine learning network.

20. The method of claim 19, wherein the feature information of the blocker includes an image of the blocker acquired using a camera of the autonomous vehicle, and
wherein the optimal beam is selected based on a success probability of beam alignment from the image acquired through the camera using the machine learning network.

21. The method of claim 19, wherein the optimal beam is selected from a candidate beam with a largest reception strength from among a plurality of candidate beams transmitted in directions corresponding to the plurality of non-line of sight (NLOS) paths.
